(19) United States
(12) Patent Application Publication
(10) Pub. No.: US 2023/0408941 A1
(43) Pub. Date: Dec. 21, 2023

(54) ELECTROPHOTOGRAPHIC TONER AND METHOD FOR PRODUCING ELECTROPHOTOGRAPHIC TONER

(71) Applicant: Konica Minolta, Inc., Tokyo (JP)

(72) Inventors: Yohei MARUYAMA, Tokyo (JP); Kazuhiko NAKAJIMA, Tokyo (JP)

(21) Appl. No.: 18/323,690

(22) Filed: May 25, 2023

(30) Foreign Application Priority Data
Jun. 16, 2022 (JP) 2022-097283

(51) Int. Cl. G03G 9/093

(52) U.S. Cl. CPC G03G 9/09385; G03G 9/09328

(57) ABSTRACT

An electrophotographic toner of the present invention includes a toner mother particle including a bright pigment and a resin layer coating the bright pigment. The bright pigment includes a bright portion and a coating layer coating the bright portion, and when the average thickness of the coating layer is A nm and the average thickness of the resin layer is B nm, the electrophotographic toner satisfies A+B≤1.600 nm.

### CROSS REFERENCE TO RELATED APPLICATIONS

The entire disclosure of Japanese Patent Application No. 2022-97283 filed on Jun. 16, 2022, is incorporated herein by reference in its entirety.

### BACKGROUND

### Technological Field

The present invention relates to a toner for electrophotography (herein also referred to as “electrophotographic toner”) and a method for producing an electrophotographic toner.

### Description of Related Art

In recent years, there has been a demand for images formed by an electrophotographic method. Such images are high value-added images as seen in the field of commercial printing in response to various customer needs. An example of such a high value-added image is an image with high brightness (image having glitter).

An electrophotographic toner including a bright pigment (glittering pigment) is used to obtain an image with high brightness by electrophotography. For example, Japanese Patent Application Laid-Open No. 2014-38131 discloses a bright toner (glittering toner) including a glittering metal pigment.

### SUMMARY

An electrophotographic toner including a bright pigment as described above is required to exhibit high brightness. A bright pigment as described in Japanese Patent Application Laid-Open No. 2014-38131 is coated with a metal oxide and a resin layer, and these coating layers are preferably thin for exhibit high brightness.

However, a production method as described in Japanese Patent Application Laid-Open No. 2014-38131 cannot reduce the thickness of a coating layer coating the bright pigment, and high brightness cannot be exhibited.

An object of the present invention is to provide an electrophotographic toner capable of exhibiting high brightness. Another object of the present invention is to provide a method for producing the electrophotographic toner.

To achieve at least one of the abovementioned objects, an electrophotographic toner reflecting one aspect of the present invention is provided. The electrophotographic toner includes a toner mother particle including a bright pigment and a resin layer coating the bright pigment, in which the bright pigment includes a bright portion and a coating layer coating the bright portion, and when the average thickness of the coating layer is A nm and the average thickness of the resin layer is B nm, the electrophotographic toner satisfies A+B≤1,600 nm.

A method for producing an electrophotographic toner reflecting one aspect of the present invention is a method for producing the above electrophotographic toner, and the method includes coating the bright pigment with the resin layer by a dry coating method.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a cross-sectional view of a toner mother particle.

### DETAILED DESCRIPTION OF EMBODIMENTS

Hereinafter, one or more embodiments of the present invention will be described with reference to the drawings. However, the scope of the invention is not limited to the disclosed embodiments.

An electrophotographic toner according to an embodiment of the present invention includes bright pigments each including a bright portion, a coating layer coating the bright portion, and a resin layer coting the bright pigment. When the average thickness of the coating layer is A nm and the average thickness of the resin layer is B nm, the electrophotographic toner satisfies A+B≤1,600 nm.

Herein, an electrophotographic toner is also simply referred to as “toner,” and the electrophotographic toner including a bright pigment is also referred to as “bright toner.” The toner mother particle in the toner of the present invention may optionally include an external additive.

The “toner mother particle” forms the base of a “toner particle.” A “toner mother particle” is referred to as a “toner particle” with the addition of an external additive. “Toner” refers to an aggregate of toner particles.

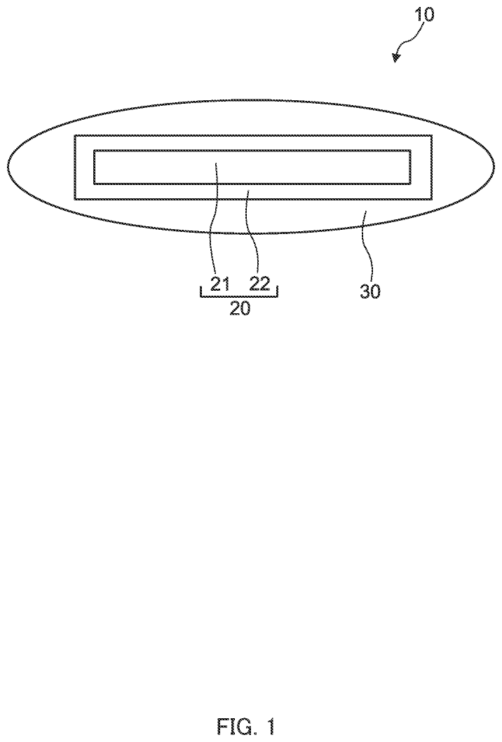

FIG. 1 illustrates a cross section of toner mother particle 10 in an electrophotographic toner according to an embodiment of the present invention.

As illustrated in FIG. 1, toner mother particle 10 includes bright pigment 20 and resin layer 30. Bright pigment 10 includes bright portion 21 and coating layer 22 coating bright portion 21.

In order for the formed image to exhibit high brightness, coating layer 22 coating bright portion 21 in bright pigment 20 and the resin layer 30 coating bright pigment 20 are preferably as thin as possible. According to the present invention, in bright pigment 20 in toner mother particle 10, when the average thickness of coating layer 22 coating bright portion 21 is A nm and the average thickness of resin layer 30 is B nm, A+B≤1,600 nm is satisfied. This configuration allows the electrophotographic toner of the present invention to exhibit high brightness. From the viewpoint of exhibiting high brightness, the value of A+B is more preferably 1,500 nm or less, still more preferably 1,000 nm or less, even more preferably 500 nm or less, and particularly preferably 150 nm or less. The lower limit of the value of A+B is not limited, but may be, for example, 100 nm or more.

The bright pigment and the resin layer will be described below.

Bright Pigment

The bright pigment exhibits high brightness by reflecting incident light. The bright pigment includes a bright portion and a coating layer, and light is mainly reflected by the bright portion. The bright portion is a highly reflective part that hardly absorbs or scatters incident light as compared with the coating layer.

The average major axis diameter of the bright pigment is preferably in the range of 3 to 30 μm, more preferably in the range of 5 to 100 μm.

The larger the area occupied by the bright pigments on a recording medium, and the more the surface where bright pigments occupy (occupied surface) spreads parallel to and uniformly on the surface of the recording media, the more light would be reflected. Therefore, from the viewpoint of exhibiting high brightness, it is preferable to arrange the toner particles according to the present invention without gaps in a location where an image to be formed on the recording medium so as to expand the occupied surface.

On the other hand, when the pigments spread too widely, bending deformation is likely to occur during the production or printing process, and the brightness of the image decreases. Therefore, it is preferable to set the average major axis diameter of the bright pigment within the above range.

The average major axis diameter can be measured from an electron micrograph obtained by using a scanning electron microscope.

In addition, the average thickness of the bright pigment is preferably in the range of 25 to 500 nm, more preferably in the range of 80 to 350 nm. When the average thickness is 25 nm or more, the light incident on the surface of the bright pigment is less likely to pass through the bright pigment and is more likely to be reflected on the surface, resulting in high brightness. In addition, the bright pigment is less likely to deform even when subjected to an external force during the production of toner particles or the formation of an image. On the other hand, when the average thickness is 500 nm or less, the bright pigment is easily arranged in parallel with the surface of the recording medium, resulting in high brightness.

The bright pigment preferably has a flat shape. When the bright pigment is flat, the surface of the bright pigment becomes parallel to the surface of the recording medium, making it easier to exhibit excellent brightness. “Flat shape” is defined as a shape having a predetermined thickness, at least two dimensions along the surface direction orthogonal to the thickness direction are larger than the thickness dimension, and defined such that an object with the flat shape is stably placed on a flat surface. The “flat shape” is, for example, a shape obtained by crushing an object with a three-dimensional shape of, for example, a sphere or a rectangular parallelepiped in one direction, and examples of such a flat shape include shapes of flakes, scales (flat small pieces), and plates. Specifically, in a bright pigment, a shape with the number average circle equivalent diameter longer than the number average maximum thickness can be said to be flat.

Bright Portion

Examples of the material that forms the bright portion in the bright pigment include metals (including alloys), metal compounds, glass, crystalline compounds, and minerals. More specific examples of the material forming the bright portion include metal powders such as aluminum, brass, bronze, nickel, stainless steel, zinc, copper, silver, gold, and platinum; mica coated with titanium oxide or yellow iron oxide; coated flaky inorganic crystal substrates such as barium sulfate, layered silicate, and layered aluminum silicate; single-crystal plate-like titanium oxide; basic carbonate; bismuth oxychloride; natural guanine; flaky glass powder; and metal-deposited flaky glass powder. These materials may be used individually, or may be used in combination. In addition, any one of various coloring materials such as dyes and pigments may be used together with the above material for color tone adjustment.

In particular, metal scales are preferable, aluminum scales are more preferable, and metal scales of aluminum metal alone are still more preferable from the viewpoints of the cost, stability, availability, and brightness.

Examples of the metal scales includes the following: products obtained by peeling a metal thin film formed by vacuum-depositing a metal or alloy on a plastic film from the plastic film, pulverizing and stirring the peeled metal thin film; and products obtained by mixing a metal or alloy powder with a solvent and spreading and/or pulverizing the powder with a mill such as a medium stirring mill, ball mill, or attritor.

In addition, as the aluminum scales, commercially available products may be used. Examples thereof include ALPASTE (registered trademark) WXM-0630 and EMERAL (registered trademark) EMR-D5660 and WJC-U75C (manufactured by Toyo Aluminium K.K.), METALURE (registered trademark) W-52012 IL and Ultravario Aqua PG-24001 (manufactured by ECKART), and Elgee (registered trademark) neo Silver #500 (silver) and Gold #500 (gold) (manufactured by OIKE & Co., Ltd.).

Coating Layer

Examples of the material that forms the coating layer coating the bright portion include oxides of the metals forming the bright portion. More specific examples include alumina, silica, titanium dioxide, and silver oxide. These materials may be used individually, or may be used in combination.

Among the materials described above, the coating layer is preferably made of alumina. A bright pigment including a coating layer is coated with a resin layer, and during the procedure, the resin layer is preferably formed by dry coating.

A dry coating method uses mechanical impact to coat a bright pigment with a resin layer. Alumina is suitable for a dry coating method because alumina has a high Mohs hardness and is resistant to mechanical impact, thus is less likely to be damaged during the formation of a resin layer by the dry coating method. When the coating layer is damaged, the exposed bright portion is damaged, resulting in a significant drop in the brightness. Further, when the bright portion is made of a conductive material such as aluminum, the exposed bright portion may cause charging failure, which adversely affects the formation of an image by electrophotography.

The thinner the coating layer is, the higher the brightness of the bright pigment is. However, a too thin coating layer may easily expose the bright portion. Damage to the exposed bright portion reduces reflectivity. From the above viewpoint, the thickness of the coating layer is preferably in the range of 5 to 800 nm, more preferably in the range of 5 to 500 nm, further preferably in the range of 5 to 150 nm, still more preferably in the range of 5 to 100 nm, even more preferably in the range of 5 to 50 nm, and particularly preferably in the range of 5 to 15 nm.

On the surface of the bright portion, the coating layer may be formed by any known method. Examples of such a known method include a sol-gel method and a method in which a metal oxide is deposited on the surface of the bright portion and crystallized at a low temperature.

On the other hand, the coating layer is already formed in some of the materials to be used as the bright portion, and in this case, there is no need to form a coating layer. For example, when aluminum is used as the bright portion, aluminum already includes alumina as a coating layer, so there is no need to form a coating layer.

Resin Layer

The resin layer coats the bright pigment. A bright pigment cannot be fixed on a recording medium by itself. Therefore, by coating the bright pigment with a resin layer to form a toner mother particle, the bright pigment can be fixed on the recording medium. The resin layer may have any structure, and may be a single layer or multiple layers composed of two or more layers. Examples of the multiple layer structures of two or more layers include core-shell structures and multi-layer structures.

The thinner the resin layer is, the higher the brightness of the bright pigment is. However, a too thin resin layer may lead to exposure of the bright pigment, which may cause charging failure.

From the above viewpoint, the average thickness of the resin layer is preferably in the range of 80 to 1,550 nm, more preferably in the range of 80 to 1,000 nm, even more preferably in the range of 80 to 500 nm, and particularly preferably in the range of 80 to 150 nm.

Any material may be used for forming the resin layer, and any binder resin commonly used in a known electrophotographic toner can be used.

Examples of the material forming the resin layer (binder resin) include polyester, vinyl resin such as styrene-acrylic resin, epoxy resin, polycarbonate, polyurethane, and composite resin including two or more of these resins. These materials may be used individually, or may be used in combination.

Among these materials, the binder resin preferably includes polyester from the viewpoint of achieving all of the low-temperature fixability, durability, and storage stability.

In addition, the resin layer is preferably formed by a dry coating method. Forming the resin layer by a dry coating method can reduce the sum of the average thickness (A) of the coating layer and the average thickness (B) of the resin layer. This will be described below.

Polymerization methods and pulverization methods are known for forming a resin layer, but these methods are not preferable from the viewpoint of obtaining an electrophotographic toner exhibiting high brightness, and dry coating methods are preferable as described above.

A polymerization method forms a resin layer around a bright pigment by polymerization. This method is a wet method using a solvent such as water or alkali. In such a method, when the bright pigment includes a metal (e.g., aluminum) as the bright portion and a metal oxide (e.g., alumina) as the coating layer, water or alkali reacts strongly with the bright portion unless the coating layer is thick. As a result, the brightness decreases. Therefore, a thick coating layer is required, and it is difficult to reduce the value of A+B and to exhibit high brightness.

A pulverization method obtains a bright pigment coated with a resin layer by forming a resin pellet including bright pigments and pulverizing the resin pellet. This method is a dry method thus possibly form a thin coating layer, but it is difficult to obtain a thin resin layer due to the principle of the method, namely pulverizing a resin pellet. Therefore, it is difficult to reduce the value of A+B and to exhibit high brightness.

On the other hand, when a bright pigment is coated with a resin layer by a dry coating method, no thick coating layer is needed because the coating is performed by a dry method. In addition, unlike a pulverization method, control of the thickness of a resin layer is easy in a dry coating method. Therefore, it becomes easy to reduce the value of A+B, and thus high brightness is more likely to be exhibited.

Herein, the “dry coating method” is, for example, a method in which resin particles are used as coating resin without using a solvent, the resin particles and bright pigments are mixed, and then the coating resin is heated to melt, thereby coating the surface of the bright pigments with the resin.

Others

The toner of the present invention may be used, for example, in an electrophotographic two-component developer including the toner of the present invention and carrier particles. Examples of the external additives to be added to the toner mother particle include waxes, charge control agents, and colored colorants.

Image Forming Method

An image forming method using an electrophotographic toner according to an embodiment of the present invention is suitable for a process in which a bright (glittering) toner image is fixed on a recording medium by a heat roller method. Specifically, the method includes, for example, the following steps (1) to (5).
(1) Charging step of charging the surface of an image bearing member
(2) Exposing step of exposing to form an electrostatic latent image on the image bearing member
(3) Developing step of developing the electrostatic latent image formed on the image bearing member with a developer including toner to form a toner image
(4) Transferring step of transferring the toner image formed on the image bearing member onto a recording medium
(5) Fixing step of fixing the toner image transferred onto the recording medium by a heat roller method Examples

The present invention will be specifically described below with reference to Examples; however, the present invention is not limited only to the following examples.

Preparation of Toner 1

First, a resin for coating a bright pigment was obtained as follows.

Into a 10-liter four-necked flask equipped with a nitrogen introduction tube, a dehydration tube, a stirrer, and a thermocouple, 4,900 parts by mass of bisphenol A-PO adduct, 1,950 parts by mass of bisphenol A-EO adduct, 1,328 parts by mass of terephthalic acid, 40 parts by mass of tin (II) 2-ethylhexanoate, and 1 part by mass of gallic acid were introduced, and reacted at 230° C. for 8 hours. Subsequently, the reaction was continued at 8.3 kPa for 1 hour. Further, the temperature was lowered to 210° C., and 5 parts by mass of trimellitic anhydride, 5 parts by mass of fumaric acid, and 5 parts by mass of tertiary butyl catechol were added and reacted until the temperature reached a desired softening point, thereby obtaining a polyester resin.

Additives were then added to the obtained polyester resin in the following manner.

The following components were premixed for 1 minute by using a Henschel mixer, and then melt-kneaded by using a twin-screw extruder “PCM-87” (manufactured by Ikegai Corp): 100 parts by mass of the polyester resin, 0.5 parts by mass of charge control agent “Bontron E-304” (negative charge control agent, manufactured by Orient Chemical Industries Co., Ltd.), and 3 parts by mass of wax “HNP-9” (paraffin wax, melting point: 79° C., manufactured by Nippon Seiro Co., Ltd.). The melt-kneading conditions were as follows: the feed amount of the materials was set to 3.0 kg/min, the screw rotation speed in the kneading section was set to 200 (rpm), the temperature of the kneaded material measured at the discharge section was set to 160° C., and the barrel set temperature was adjusted to 170° C., thereby obtaining a kneaded product. The resulting kneaded product was cooled to 20° C. or lower while being rolled with a cooling roll, and the cooled melt-kneaded product was coarsely pulverized to about 3 mm by Rotoplex (manufactured by Toa Kikai Co., Ltd.).

The resulting coarsely pulverized material is coarsely pulverized to have a volume median particle size (D50) of 1.5 to 2.5 mm by using a cutter mill (manufactured by Nara Machinery Co., Ltd.), and then subjected to further pulverization by using a collision plate type jet mill “type 1-20” (manufactured by Nippon Pneumatic Mfg. Co., Ltd.). Finely pulverized resin particles were thus obtained.

Next, toner mother particles were obtained by coating the bright pigments with resin layers by a dry coating method in the following manner.

A high-speed mixer with stirring blades was charged with 35 parts by mass of the finely pulverized resin particles and 50 parts by mass of flat aluminum pigments 1 (major axis diameter of the pigment: 12 μm, an alumina layer as a coating layer: 10 nm). Under a nitrogen atmosphere, the mixture was stirred and mixed at 120° C. for 1 hour to obtain toner mother particles 1 each including the bright pigment coated with the resin by using a mechanical impact force.

Next, toner particles (toner) were obtained by adding additives to the toner mother particles in the following manner.

To 100 parts by mass of the toner mother particles obtained as described above, 0.8 parts by mass of silica fine particles was added, and the mixture was charged to a Henschel mixer model “FM20C/I” (manufactured by Nippon Coke & Engineering Co., Ltd.). The rotation speed was set so that the peripheral speed at the blade tip is adjusted to 50 m/s, and the mixture was stirred for 20 minutes to obtain toner particles 1 (toner 1).

Preparation of Toner 2

Toner 2 was obtained in the same manner as in the preparation of Toner 1 except that 200 parts by mass of the resin particles and 50 parts by mass of flat aluminum pigments 1 (major axis diameter of the pigment: 12 μm, an alumina layer as a coating layer: 10 nm) were used.

Preparation of Toner 3

Toner 3 was obtained in the same manner as in the preparation of Toner 1 except that 350 parts by mass of the resin particles and 50 parts by mass of flat aluminum pigments 1 (major axis diameter of the pigment: 12 μm, an alumina layer as a coating layer: 10 nm) were used.

Preparation of Toner 4

Toner 4 was obtained in the same manner as in the preparation of Toner 1 except that 500 parts by mass of the resin particles and 50 parts by mass of flat aluminum pigments 1 (major axis diameter of the pigment: 12 μm, an alumina layer as a coating layer: 10 nm) were used.

Preparation of Toner 5

Toner 5 was obtained in the same manner as in the preparation of Toner 1 except that 130 parts by mass of the resin particles and 50 parts by mass of flat aluminum pigments 2 (major axis diameter of the pigment: 2.8 μm, an alumina layer as a coating layer: 15 nm) were used.

Preparation of Toner 6

Toner 6 was obtained in the same manner as in the preparation of Toner 1 except that 150 parts by mass of the resin particles and 50 parts by mass of flat aluminum pigments 3 (major axis diameter of the pigment: 32 μm, an alumina layer as a coating layer: 20 nm) were used.

Preparation of Toner 7

Toner 7 was obtained in the same manner as in the preparation of Toner 1 except that 35 parts by mass of the resin particles and 50 parts by mass of flat aluminum pigments 4 (major axis diameter of the pigment: 12 μm, an alumina layer as a coating layer: 40 nm) were used.

Preparation of Toner 8

Toner 8 was obtained in the same manner as in the preparation of Toner 1 except that 190 parts by mass of the resin particles and 50 parts by mass of flat aluminum pigments 4 (major axis diameter of the pigment: 12 μm, an alumina layer as a coating layer: 40 nm) were used.

Preparation of Toner 9

Toner 9 was obtained in the same manner as in the preparation of Toner 1 except that 330 parts by mass of the resin particles and 50 parts by mass of flat aluminum pigments 4 (major axis diameter of the pigment: 12 μm, an alumina layer as a coating layer: 40 nm) were used.

Preparation of Toner 10

Toner 10 was obtained in the same manner as in the preparation of Toner 1 except that 480 parts by mass of the resin particles and 50 parts by mass of flat aluminum pigments 4 (major axis diameter of the pigment: 12 μm, an alumina layer as a coating layer: 40 nm) were used.

Preparation of Toner 11

Toner 11 was obtained in the same manner as in the preparation of Toner 1 except that 40 parts by mass of the resin particles and 50 parts by mass of flat aluminum pigments 5 (major axis diameter of the pigment: 12 μm, an alumina layer as a coating layer: 100 nm) were used.

Preparation of Toner 12

Toner 12 was obtained in the same manner as in the preparation of Toner 1 except that 170 parts by mass of the resin particles and 50 parts by mass of flat aluminum pigments 5 (major axis diameter of the pigment: 12 μm, an alumina layer as a coating layer: 100 nm) were used.

Preparation of Toner 13

Toner 13 was obtained in the same manner as in the preparation of Toner 1 except that 300 parts by mass of the resin particles and 50 parts by mass of flat aluminum pigments 5 (major axis diameter of the pigment: 12 μm, an alumina layer as a coating layer: 100 nm) were used.

Preparation of Toner 14

Toner 14 was obtained in the same manner as in the preparation of Toner 1 except that 430 parts by mass of the resin particles and 50 parts by mass of flat aluminum pigments 5 (major axis diameter of the pigment: 12 μm, an alumina layer as a coating layer: 100 nm) were used.

Preparation of Toner 15

Toner 15 was obtained in the same manner as in the preparation of Toner 1 except that 25 parts by mass of the resin particles and 50 parts by mass of flat aluminum pigments 6 (major axis diameter of the pigment: 12 μm, an alumina layer as a coating layer: 490 nm) were used.

Preparation of Toner 16

Toner 16 was obtained in the same manner as in the preparation of Toner 1 except that 110 parts by mass of the resin particles and 50 parts by mass of flat aluminum pigments 6 (major axis diameter of the pigment: 12 μm, an alumina layer as a coating layer: 490 nm) were used.

Preparation of Toner 17

Toner 17 was obtained in the same manner as in the preparation of Toner 1 except that 190 parts by mass of the resin particles and 50 parts by mass of flat aluminum pigments 6 (major axis diameter of the pigment: 12 μm, an alumina layer as a coating layer: 490 nm) were used.

Preparation of Toner 18

Toner 18 was obtained in the same manner as in the preparation of Toner 1 except that 20 parts by mass of the resin particles and 50 parts by mass of flat aluminum pigments 7 (major axis diameter of the pigment: 12 μm, an alumina layer as a coating layer: 760 nm) were used.

Preparation of Toner 19

Toner 19 was obtained in the same manner as in the preparation of Toner 1 except that 130 parts by mass of the resin particles and 50 parts by mass of flat aluminum pigments 7 (major axis diameter of the pigment: 12 μm, an alumina layer as a coating layer: 760 nm) were used.

Preparation of Toner 20

Toner 20 was obtained in the same manner as in the preparation of Toner 1 except that 120 parts by mass of the resin particles and 50 parts by mass of flat aluminum pigments 6 (major axis diameter of the pigment: 12 μm, an alumina layer as a coating layer: 490 nm) were used.

Preparation of Toner 21

Toner 21 was obtained in the same manner as in the preparation of Toner 1 except that 230 parts by mass of the resin particles and 50 parts by mass of flat aluminum pigments 7 (major axis diameter of the pigment: 12 μm, an alumina layer as a coating layer: 760 nm) were used.

Preparation of Toner 22

Toner 22 was obtained in the same manner as in the preparation of Toner 1 except that 240 parts by mass of the resin particles and 50 parts by mass of flat aluminum pigments 7 (major axis diameter of the pigment: 12 μm, an alumina layer as a coating layer: 760 nm) were used.

Evaluation

For each toner obtained as described above, the average major axis diameter of the bright pigments, the average thickness of the coating layers of the mother particles, the average thickness of the resin layers, and the brightness were evaluated as follows.

Average Major Axis Diameter

The average major axis diameter of the bright pigments was measured by an electron micrograph taken by a scanning electron microscope (SEM) “JSM-7401F” (manufactured by JEOL Ltd.). Specifically, the major axis diameters of 1,000 bright pigments were measured, and the number average major axis diameter was calculated.

Average Thickness of Coating layer and Average Thickness of Resin Layer

The toner mother particles were dispersed in a photocurable resin “D-800” (manufactured by JEOL Ltd.), which was cured, thereby embedding the particles in the photocurable resin.

The sample after the embedding is processed into a flat plate shape by using a razor, fixed to a sample holder for ion milling with thermoplastic wax. The cut surface was subjected to an ion milling process by using an ion milling processing device “SM-09010” (manufactured by JEOL Ltd.), thereby preparing a sample for cross-sectional observation.

The cross section was taken along the major axis direction of the flat bright pigment and perpendicular to the surface of the flat bright pigment.

The ion milling process was performed under the following conditions: acceleration voltage of 5.0 kV, beam current of 60 ρA, set time of 12 hours, and ion species Ar⁺.

The thickness of the resin layer and the coating layer of the sample obtained for cross-sectional observation was determined by using a scanning electron microscope (SEM) “JSM-7401F” (manufactured by JEOL Ltd.) with an energy dispersive X-ray spectrometer (EDS) “JED-2300” (manufactured by JEOL Ltd.) incorporated therein. Specifically, the sample obtained for cross-sectional observation was subjected to elemental mapping to obtain an image in which the bright portions, the coating layers, and the resin layers were clarified. The EDS conditions were as follows: acceleration voltage of 20 kV, irradiation current of 2.56 nA, and PHA mode of T3. Next, the thicknesses of the resin layer and the coating layer were measured as follows.

As for the resin layer, the lengths of vertical lines from 20 random points on the outline of the outermost surface of the toner mother particle to the surface of the coating layer of the bright pigment were measured in the image. The 20 random points were spaced apart from each other by at least 100 nm, and any location where the resin was peeled off from the bright pigment and the bright pigment was exposed was excluded from the random points.

As for the coating layer, the lengths of vertical lines from 20 random points on the bright portion to the surface of the coating layer were measured in the image. The 20 random points are spaced apart from each other by at least 100 nm.

As described above, the average values of the thicknesses of the resin layer and the coating layer from 20 random points were calculated. Further, the calculation of the above average values were performed for 100 random toner mother particles. The obtained average values (for the for 100 random toner mother particles) were subjected to further calculation to obtain “average thickness of coating layer” and “average thickness of resin layer.”

Brightness

The above toner is stored in a commercially available color multifunction machine (Bizhub PRO C6500, manufactured by KONICA MINOLTA, INC.), and using the multifunction machine, a toner image with a square patch image of 2 cm×2 cm (deposition amount of 5 g/m²) was output on A4 high-quality paper (65 g/m) at a fixing temperature of 180° C.

The obtained toner image was measured by a goniometer device (measuring instrument for deflection angle spectral reflectance, Gonio Photometer GP-5, manufactured by Murakami Color Research Laboratory) as follows: the lightness L* of light (at an incident angle of 60°) specularly reflected by the toner image surface at a reflection angle of 60° was measured. The calibration was performed with the lightness of light (at an incident angle of 60°) specularly reflected by the surface of a standard white plate at a reflection angle of 60° as 100. Lightness L* of 300 or more was evaluated as good.

Table 1 below shows the evaluation results of each toner.

TABLE 1

| | Bright pigment | | | | Average thickness | | |
|---|---|---|---|---|---|---|---|
| | | Average major | Average thickness | Average thickness | of coating layer + | | |
| Toner | | axis diameter | of coating layer | of resin layer (B) | average thickness of | | |
| No. | No. | [μm] | (A) [nm] | [nm] | resin layer (A + B) | L* | Remarks |
| 1 | 1 | 12 | 10 | 110 | 120 | 420 | Example |
| 2 | 1 | 12 | 10 | 480 | 490 | 400 | Example |
| 3 | 1 | 12 | 10 | 980 | 990 | 380 | Example |
| 4 | 1 | 12 | 10 | 1,480 | 1,490 | 360 | Example |
| 5 | 2 | 2.8 | 15 | 480 | 495 | 350 | Example |
| 6 | 3 | 32 | 20 | 520 | 540 | 340 | Example |
| 7 | 4 | 12 | 40 | 90 | 130 | 400 | Example |
| 8 | 4 | 12 | 40 | 460 | 500 | 390 | Example |
| 9 | 4 | 12 | 40 | 970 | 1,010 | 360 | Example |
| 10 | 4 | 12 | 40 | 1,510 | 1,550 | 330 | Example |
| 11 | 5 | 12 | 100 | 130 | 140 | 390 | Example |
| 12 | 5 | 12 | 100 | 510 | 610 | 360 | Example |
| 13 | 5 | 12 | 100 | 1,020 | 1,120 | 320 | Example |
| 14 | 5 | 12 | 100 | 1,490 | 1,590 | 300 | Example |
| 15 | 6 | 12 | 490 | 130 | 620 | 370 | Example |
| 16 | 6 | 12 | 490 | 510 | 1,000 | 330 | Example |
| 17 | 6 | 12 | 490 | 980 | 1,480 | 300 | Example |
| 18 | 7 | 12 | 760 | 120 | 890 | 340 | Example |
| 19 | 7 | 12 | 760 | 490 | 1,250 | 320 | Example |
| 20 | 6 | 12 | 490 | 1,490 | 1,980 | 280 | Comparative |
| | | | | | | | Example |
| 21 | 7 | 12 | 760 | 980 | 1,740 | 290 | Comparative |
| | | | | | | | Example |
| 22 | 7 | 12 | 760 | 1,450 | 2,210 | 270 | Comparative |
| | | | | | | | Example |

The comparison between Toners 1 to 19 of Examples and Toners 20 to 22 of Comparative Examples shows that the brightness of Examples was 300 L* or more, indicating high brightness. This is because the sum of the average thickness (A nm) of the coating layer and the average thickness (B nm) of the resin layer is 1,600 nm or less in the toners 1 to 19 of Examples.

### INDUSTRIAL APPLICABILITY

The present invention is capable of providing an electrophotographic toner excellent in brightness. Accordingly, the present invention is capable of providing an image with excellent brightness by electrophotography.

Although embodiments of the present invention have been described and illustrated in detail, the disclosed embodiments are made for purposes of illustration and example only and not limitation. The scope of the present invention should be interpreted by terms of the appended claims.

What is claimed is:

1. An electrophotographic toner, comprising:
a toner mother particle including a bright pigment and a resin layer coating the bright pigment, wherein
the bright pigment includes a bright portion and a coating layer coating the bright portion, and
when an average thickness of the coating layer is A nm and an average thickness of the resin layer is B nm, the electrophotographic toner satisfies A+B≤1,600 nm.

2. The electrophotographic toner according to claim 1, wherein the average thickness of the coating layer is in a range of 5 to 100 nm.

3. The electrophotographic toner according to claim 1, wherein an average major axis diameter of the bright pigment is in a range of 3 to 30 μm.

4. The electrophotographic toner according to claim 1, wherein the bright portion is aluminum and the coating layer is alumina.

5. A method for producing the electrophotographic toner according to claim 1, the method comprising coating the bright pigment with the resin layer by a dry coating method.
